(19) United States
(12) Patent Application Publication
(10) Pub. No.: US 2026/0326971 A1
(43) Pub. Date: Oct. 22, 2026

(54) CONTAINER ARRANGEMENT AND METHOD FOR ITS MANUFACTURE

(71) Applicant: Variotech GmbH, Nordhorn (DE)

(72) Inventors: Benedikt FLEIG, Pulheim (DE); Eric ZEITEL, Neuenhaus (DE); Volkhard GERIG, Nordhorn (DE)

(21) Appl. No.: 19/629,480

(22) Filed: Mar. 26, 2026

(30) Foreign Application Priority Data
Apr. 17, 2025 (DE) 10 2025 115 137.7

(51) Int. Cl. B65D 21/02; B65D 43/02; B65D 53/02; B65D 79/00

(52) U.S. Cl. CPC B65D 21/0213; B65D 43/0212; B65D 53/02; B65D 79/0084; B65D 2543/00194; B65D 2543/00527; B65D 2543/00537; B65D 2543/00648; B65D 2543/00759; B65D 2543/00972

(57) ABSTRACT

A container arrangement may have a number of containers and a container closure lid. Each container may have a container base to which a side wall is circumferentially connected. The side wall may have a circumferential upper stacking edge in an upper area and a circumferential lower stacking edge in a lower area. A pressure equalization element with a moisture barrier membrane may be arranged in the side wall. A container seal may be circumferentially arranged at the lower stacking edge. A lid seal may be circumferentially arranged at the container closure lid. A method for manufacturing the container arrangement is also provided.

### FIELD

The invention relates to a container arrangement and a method for its manufacture.

### BACKGROUND

DE 199 64 255 C2 discloses a plastic transport container with a base and a surrounding side wall formed from the same material as the base, as well as flanges protruding around the entire outer edge of the container via the outer contour of the side wall. The flanges form an angle of less than 90° with the side wall on their underside and are designed as an inwardly open groove.

Furthermore, DE 199 27 069 C2 discloses a plastic transport container formed as a thermoformed plastic part with a base and a surrounding side wall formed from the same material as the base. The transport container comprises a flange designed as a hollow profile, which protrudes around the entire outer side of the container beyond the outer contour of the side wall. The flange is designed as an open groove towards the inside of the container and is arranged at a distance from the base. A side wall connecting to the flange at the bottom is set back by at least one wall thickness of the side wall, and the flange forms an angle of less than 90° with the side wall at its bottom. A simple circumferential flange is provided at the upper edge of the side wall, which forms an angle of less than 90° with the outer wall at its bottom.

In addition, DE 10 2019 207 818 A1 discloses a tool and a method for manufacturing a plastic container in a thermoforming process, in particular a plastic deep-drawing process. The tool has a positive mold comprising a bottom section for forming a container bottom, a side wall section for forming a circumferential side wall formed from the same material as the container bottom, a wall for forming a stacking rim, which is designed as a hollow profile and projects around the entire outer side of the container beyond the outer contour of the side wall of the container, which is designed as an open groove towards the inside of the container and is arranged at a distance from the container base. The wall is arranged in a molding position for molding the container so that it protrudes around the entire outer side of the positive mold. An angle of less than 90° is formed between a wall side facing the bottom section and an area of the associated side wall section extending from this wall side towards the bottom section. The wall can be moved from the molding position to a demolding position in which the distance between an end of the wall protruding in the molding position and the side wall section is reduced.

### SUMMARY

The object of the invention is to provide a container arrangement that is improved over the prior art and a method for manufacturing it that is improved over the prior art.

The object is achieved according to the invention by a container arrangement with the features of claim 1 and by a method for manufacturing a container arrangement with the features of claim 7.

Advantageous embodiments of the invention are the subject of the dependent claims.

A container arrangement according to the invention has a number of containers, i.e., at least one container, but advantageously several containers, i.e., at least two or more containers. The respective container is in particular a transport container and/or storage container, in particular for transporting and/or storing components. The respective container is in particular made of plastic, in particular in a thermoforming process, in particular a plastic deep-drawing process.

Furthermore, the container arrangement advantageously has a container closure lid. The container closure lid is in particular made of plastic, in particular in a thermoforming process, in particular a plastic deep-drawing process. The container closure lid is in particular closed, in particular media-tight, in particular liquid-tight. The respective container has a container base, in particular a closed container base, to which a side wall is circumferentially connected, the side wall having a circumferential upper stacking edge in an upper area and a circumferential lower stacking edge in a lower area.

A pressure equalization element is advantageously arranged in the side wall, which in particular has a moisture barrier membrane. With the exception of a receiving opening for the pressure equalization element, the side wall is advantageously designed to be closed, in particular media-tight, in particular liquid-tight. The receiving opening in the side wall is closed, in particular sealed, by the pressure equalization element arranged therein, so that pressure equalization via the side wall can only take place through the pressure equalization element. The pressure equalization element is also referred to as a pressure equalization valve.

Advantageously, a container seal is circumferentially arranged at the lower stacking edge. Advantageously, a lid seal is circumferentially arranged at the container closure lid. The lid seal is arranged in particular on an underside of the container closure lid. It is arranged in particular in a circumferential edge area of the container closure lid, in particular at the underside of the container closure lid.

The container seal of the respective container is arranged and designed in such a way that, when two containers are stacked on top of each other, the container seal of the upper container fits tightly against the upper stacking edge of the lower container. It thus rests against the upper stacking edge of the lower container and against the lower stacking edge of the upper container, thereby circumferentially sealing an upper container opening of an interior of the lower container. This container opening of the lower container is thus sealed by the container base and the container seal of the upper container. As already mentioned, the container base is closed and thus designed to be media-tight, in particular liquid-tight.

The lid seal of the container closure lid is arranged and designed in particular in such a way that, when the container closure lid is placed on the container, the lid seal fits tightly against the upper stacking edge of the container. It thus rests against the upper stacking edge of the container and against the container closure lid, in particular against its underside, thereby circumferentially sealing the upper container opening of the container interior. The container opening of the container is thus sealed by the container closure lid and the lid seal.

The container seal of the respective container is formed in particular from a PU foam, also referred to as PUR-foam, in particular from a 2K-PU-foam. The lid seal is formed in particular from a PU foam, also referred to as PUR-foam, in particular from a 2K-PU-foam. The abbreviation PU stands for polyurethane. The abbreviation 2K stands for two components.

The moisture barrier membrane of the pressure equalization element is formed in particular as a microporous membrane or as a hydrophilic membrane. The moisture barrier membrane, in particular the moisture barrier membrane formed as a microporous membrane, is formed in particular from stretched polytetrafluoroethylene, also referred to as expanded polytetrafluoroethylene (ePTFE).

In particular, it is envisaged that the container closure lid has locking elements that are designed to lock onto an outer edge of the upper stacking edge when the container closure lid is placed on the container. The locking elements are formed, for example, as locking catches which are formed circumferentially around a side edge of the container closure lid and distributed on this side edge of the container closure lid. This ensures in particular that, when the container closure lid is placed on the container and locked to the container by means of the locking elements, the lid seal is pressed against the upper stacking edge of the container with a predetermined pressing force, in particular in a predetermined manner.

In a method according to the invention for manufacturing the container arrangement, the receiving opening for the pressure equalization element is made in the side wall of the respective container, the pressure equalization element is arranged in the receiving opening, advantageously the container seal is circumferentially arranged at the lower stacking edge of the respective container, and advantageously the lid seal is circumferentially arranged at the container closure lid. The steps described can be carried out in the order described or in a different order. In particular, the insertion of the receiving opening and/or the arrangement of the pressure equalization element can be carried out before or after the arrangement of the container seal and/or before or after the arrangement of the lid seal, and the arrangement of the container seal can be carried out before or after the arrangement of the lid seal.

The pressure equalization element is particularly easy to install, enables quick and easy integration, and ensures stable performance. It is in particular waterproof. In particular, it provides IP66/IP68 protection. It is in particular safe and reliable. It is in particular air-permeable. It has in particular an air permeability of 350-4000 ml/min@0.07bar. The membrane material is in particular ePTFE, as already mentioned above. It has in particular oleophobic and/or hydrophobic membrane properties. The pressure equalization element has in particular a housing and a clamping nut. The housing is in particular made of plastic, in particular fiber-reinforced plastic, in particular glass fiber-reinforced plastic. The plastic is in particular polyamide. The housing is in particular made of PA66 and, in particular, 25 % glass fiber. The clamping nut is in particular made of plastic, in particular polyamide, in particular PA66. The pressure equalization element has in particular a seal for sealing the connection between the pressure equalization element and the side wall. This seal is in particular designed as an O-ring, in particular made of silica gel, in particular with a Shore hardness A of 60H.

In one embodiment, the respective plastic container is formed in a thermoforming process, in particular a plastic deep-drawing process, for example by means of the tool and/or method described in DE 10 2019 207 818 A1, in particular in its figure description and figures.

In one embodiment, the plastic container closure lid is formed in a thermoforming process, in particular a plastic deep-drawing process.

The receiving opening is introduced into the side wall of the respective container, for example, during or after the formation of the container. The introduction after the formation of the respective container can be carried out, for example, by drilling or punching.

The container seal is formed on the respective container, in particular by applying PU foam, especially in the form of a foam bead. The PU foam used to form the container seal is, in particular, an addition-curing 2-component PUR foam. It is, in particular, a PUR material that can be applied directly using a mixing and dosing machine.

In one possible embodiment of the respective container, the respective container has a groove, in particular a circumferential groove, at the lower stacking edge, wherein the container seal is formed in this groove. This means that the PUR material used to form the container seal can be, for example, a liquid material that can be applied to components, in particular 2D components, with a groove. This PUR material has, in particular, a mixed-cell foam structure. In particular, it has a relatively lower compression hardness in comparison to closed-cell systems. In particular, it does not require any additional oven post-treatment for curing, but curing can be accelerated, for example, with heat. In particular, it has good resilience, especially in the cured state. In the cured state, the PU foam has a density of approx. 0.30 g/cm³, a surface hardness (Shore 00) of approx. 66 and/or a service temperature of -40 °C to +80 °C, in particular up to +160 °C for short periods. The curing time of the PU foam is, for example, one hour to 12 hours. An A component of the raw product, i.e., before curing of the PU foam, has, for example, a density of approx. 1.17 g/cm³ and/or a viscosity of approx. 4000 mPa*s.

The lid seal is formed on the container closure lid, in particular by applying PU-foam, especially in the form of a foam bead. The PU-foam used to form the lid seal is, in particular, an addition-curing 2-component PUR-soft-foam. It is, in particular, a paste-like (thixotropic) material that can be applied to 2D and 3D components with or, in particular, without a groove. In particular, it has a mixed-cell foam structure. In particular, it does not require any additional oven post-treatment for curing, but curing can be accelerated, for example, with heat. In particular, in the cured state, it has good resilience and low water absorption. In the cured state, the PU foam in particular has a density of 0.22 to 0.36 g/cm³, a surface hardness (Shore 00) of approx. 46 to 65 and/or a service temperature of -40 °C to +80 °C, in particular up to +160 °C for short periods. The curing time of the PU foam is, for example, one hour to 12 hours. An A component of the raw product, i.e., before the PU foam has cured, has, for example, a density of 1.00 to 1.06 g/cm³ and/or a viscosity of 35,000 to 55,000 mPa*s.

For example, the container closure lid does not have a groove for the lid seal, but rather a flat surface on which the lid seal is attached. Therefore, the PU foam used is in particular the paste-like (thixotropic) material. If the container closure lid has a groove for the lid seal, the material used above to form the container seal can also be used to form the lid seal, for example. Similarly, if the respective container does not have a groove for the container seal, the material used above to form the lid seal can be used to form the container seal, for example.

The container seal and/or lid seal, in particular in the form of a foam bead, is applied in particular using the FIPFG (Formed-In-Place-Foam-Gaskets) process. The container seal and/or lid seal is in particular applied "in situ," with the two-component material being applied directly to the component at the location where the seal is required. The container seal or lid seal then advantageously hardens at room temperature.

The design of the container seal and/or lid seal made of PU foam is particularly advantageous because its shape allows it to be easily adapted to the shape of the respective component, in this case the respective container or container lid, because it can be applied automatically without the risk of loss, adhere without additional adhesive tape, and the start and end points of the foam bead merge into each other thanks to overlapping, so that no disadvantageous coupling points and no open joints or incisions are created, parameters such as the width, height, and hardness of the seal can be influenced by their design, and there is less potential for error compared to manual application.

Furthermore, the design of the container seal and/or lid seal made of PU foam is highly economical, as it is of higher quality and significantly cheaper than manually inserted seals.

The formation of the container seal and/or lid seal from PU foam also enables short cycle times and thus efficient automated production.

Furthermore, the formation of the container seal and/or lid seal from PU foam results in low storage requirements and, compared to stamped or cut seals, virtually no waste is produced.

The formation of the container seal and/or the lid seal from PU foam is also environmentally friendly, as the application system can be rinsed with water, adhesive-free application is possible, and curing at room temperature is possible after around four to 20 minutes without an oven.

The solution described here for the container arrangement and the method for its manufacture makes it possible, in particular, to avoid moisture damage to components stored and/or transported in the respective container. The solution described thus enables, in particular, the transport and/or storage of components at risk of corrosion, for example untreated metals and/or electrical and/or electronic parts and assemblies.

The solution described here solves in particular the problem that condensate or water vapor forms in transport containers known in the art when temperatures change during storage and transport, which can cause corrosion of metals and damage to electronic components.

This is solved by the solution described here, in particular by sealing the interior of the respective container, either by means of another container stacked on top of it and its container seal, or by means of the container closure lid and its lid seal, as well as by the pressure equalization element of the respective container. Both this sealing and the pressure equalization element prevent moisture from entering the interior of the respective container, whereby the pressure equalization element also allows moisture, in particular water vapor, to escape from the interior of the respective container.

The solution described here therefore eliminates the need for additional chemical protection (VCI—volatile corrosion inhibitor) in the form of coated film, paper, capsules, etc. This results in lower costs and easier handling, as well as less waste, since conventional chemical protection components are usually disposable products.

These advantages are achieved in the manner described above, summarized in particular by the fact that, especially in the bottom area of the respective container, i.e., in particular at the lower stacking edge, the container seal is inserted, which, in a stack of several containers, makes sealing contact with the upper stacking edge of the other container arranged below and thereby seals the latter, in particular its interior. This means that not every container needs a container closure lid, but only the top container when several containers are stacked on top of each other. This top container is provided with the container closure lid of the solution described, which is provided with the lid seal. A single container can also be provided with this container closure lid and used.

In addition, the respective container is equipped with the pressure equalization element, which, thanks to its membrane, in particular a moisture barrier membrane, can transport moisture out of the container but, advantageously, does not allow moisture to penetrate from the outside. Advantageously, a size of the pressure equalization element and/or a throughput enabled by the pressure equalization element is adapted to an internal volume of the respective container, i.e., the pressure equalization element used for the respective container is advantageously selected accordingly.

In an advantageous embodiment, in particular if the respective container, as already mentioned above, is manufactured or will be manufactured by means of the tool and/or process described in DE 10 2019 207 818 A1, in particular in its figure description and figures, before the receiving opening is made in its side wall, the pressure equalization element is arranged and the container seal is arranged, it is in particular provided that the container has a container base whose properties are advantageously adapted to a good to be transported. For example, the container base is profiled in such a way that it has so-called nests, which enable the components to be inserted to be transported without slipping or damage. However, depending on requirements, the container base may also have other properties, for example, it may be flat.

The side wall is circumferentially connected to the container base, which side wall is preferably made of the same material, and which side wall advantageously ends in an upper flange in the upper area, which is circumferentially formed around the entire container, preferably made of the same material, and protrudes in particular beyond an outer side of the side wall. This upper flange, in particular an upper side of the upper flange, advantageously forms the upper stacking edge.

In the lower area of the container, in particular the side wall, a lower flange projecting outwards is advantageously formed, which advantageously forms the lower stacking edge. The lower flange is in particular formed as an inwardly open groove and thus has an upper side and a lower side, whereby in particular the lower side forms the lower stacking edge. Advantageously, a section of the side wall protruding downwards from the lower flange in this area is set back by a distance relative to the rest of the side wall, which corresponds to at least one material thickness of the side wall, but is slightly larger in a possible design, so that several containers can be stacked on top of each other and section by section into each other without jamming.

The lower flange is advantageously inclined on its underside relative to the adjoining section of the side wall and forms an angle with the section of the side wall that is less than 90°.

The upper flange also advantageously forms an angle that is less than 90°, so that when several containers are stacked, the upper flange, i.e. the upper stacking edge of the lower container fits with its upper side under the underside of the lower flange, i.e., the lower stacking edge of the upper container located directly above it, whereby the container seal located on the lower stacking edge of the upper container, in particular on the underside of the lower stacking edge, is now arranged in a sealing manner between the lower stacking edge of the upper container and the upper stacking edge of the lower container, thereby achieving a dust- and moisture-tight connection between the individual containers when stacked.

The respective container has, for example, a length of 400 mm, 600 mm, or 800 mm and/or a width of 300 mm, 400 mm, or 600 mm, in particular a length of 400 mm and a width of 300 mm, or a length of 600 mm and a width of 400 mm, or a length of 800 mm and a width of 600 mm.

### DESCRIPTION OF THE FIGURES

Examples of embodiments of the invention are explained in more detail below with reference to drawings.

FIG. 1 is a schematic perspective view of a container,

FIG. 2 is a schematic top view of the container,

FIG. 3 is a schematic cross-sectional view of the container corresponding to section III-III in FIG. 2,

FIG. 4 is a schematic side view of the container,

FIG. 5 is a schematic top view of the container from below, i.e., onto the underside of the container,

FIG. 6 is a schematic cross-sectional view of the container corresponding to the section plane VI-VI in FIG. 5,

FIG. 7 is a schematic detailed view of detail section VII in FIG. 6,

FIG. 8 is a schematic representation of a container arrangement with two containers stacked on top of each other and a container closure lid on the upper container in a top view from above,

FIG. 9 is a schematic cross-sectional view of the container arrangement corresponding to the section plane IX-IX in FIG. 8,

FIG. 10 is a schematic detailed view of detail X in FIG. 9,

FIG. 11 is a schematic perspective view of a container arrangement with a container and a container closure lid on the container,

FIG. 12 is a schematic top view of the container arrangement from FIG. 11,

FIG. 13 is a schematic cross-sectional view of the container arrangement corresponding to the section plane XIII-XIII in FIG. 12,

FIG. 14 is a schematic detailed view of detail XIV in FIG. 13,

FIG. 15 is a schematic representation of the container arrangement from FIG. 11 in another top view from above,

FIG. 16 is a schematic cross-sectional view of the container arrangement corresponding to the section plane XVI-XVI in FIG. 15, and

FIG. 17 is a schematic detailed view of detail XVII in FIG. 16.

### DETAILED DESCRIPTION

Corresponding parts are designated with the same reference numerals in all figures.

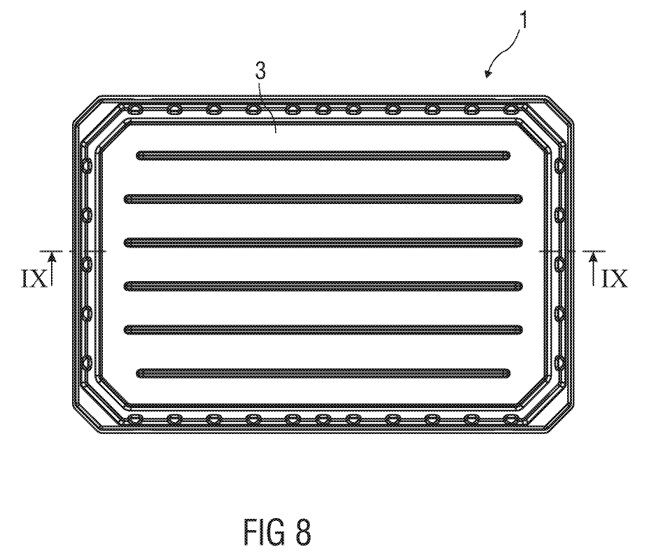

FIGS. 1 - 17 are used below to describe a container arrangement 1 and a method for its manufacture. The container arrangement 1 has a number of containers 2, i.e. at least one container 2, as shown for example in FIGS. 1 - 7 and 11 -17, or advantageously several containers 2, i.e. at least two containers 2, as shown for example in FIGS. 8 - 10, or more than two containers 2.

Furthermore, the container arrangement 1 advantageously has a container closure lid 3, as shown, for example, in FIGS. 8 - 17.

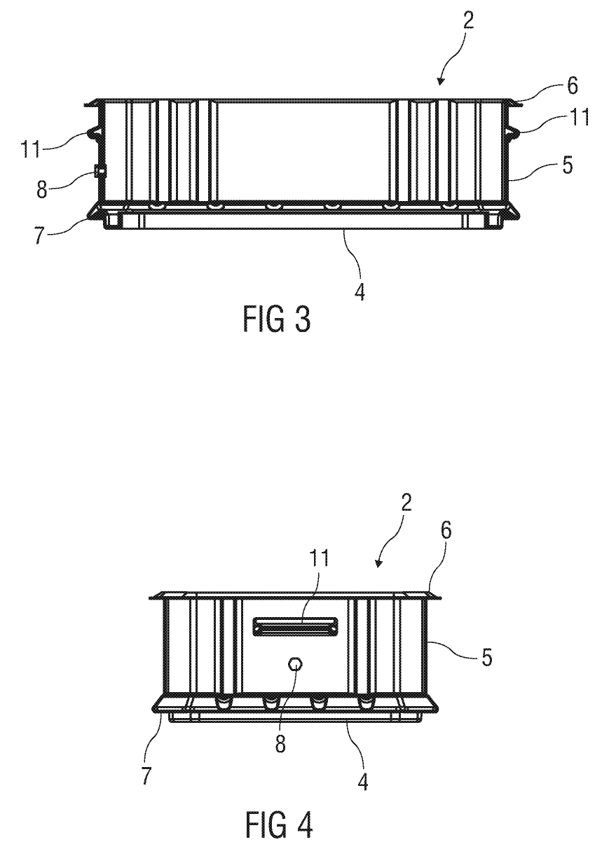

FIGS. 1-7 show only container 2, and FIGS. 8- 17 show the respective embodiment of the container arrangement 1 with one container 2 or with two containers 2 and with the container closure lid 3.

The respective container 2 is, in particular, a transport container and/or storage container, in particular for transporting and/or storing components. The respective container 2 is, in particular, made of plastic, in particular in a thermoforming process, in particular a plastic deep-drawing process.

Advantageously, the container closure lid 3 is also made of plastic, in particular in a thermoforming process, in particular a plastic deep-drawing process. The container closure lid 3 is in particular formed closed, in particular media-tight, in particular liquid-tight.

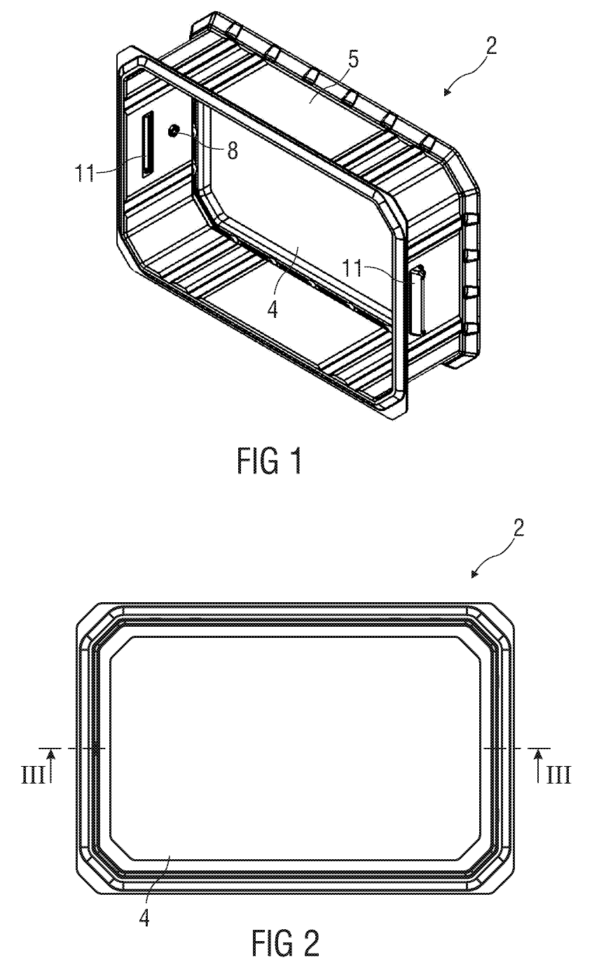

The respective container 2 has a closed container base 4. FIGS. 1 and 2 show a top view of an upper side, i.e., an inner side, of the container base 4. FIG. 5 shows a top view of a lower side, i.e., an outer side, of the container base 4.

A side wall 5 is circumferentially connected to the container base 4, which side wall 5 has a circumferential upper stacking edge 6 in an upper area and a circumferential lower stacking edge 7 in a lower area.

As shown in FIGS. 1, 3, and 4, in the embodiments shown, a pressure equalization element 8 is arranged in the side wall 5, which in particular has a moisture barrier membrane. With the exception of a receiving opening for the pressure equalization element 8, the side wall 5 is closed, in particular media-tight, in particular liquid-tight. The receiving opening in the side wall 5 is closed, in particular sealed, by the pressure equalization element 8 arranged therein, so that pressure equalization via the side wall 5 can only take place through the pressure equalization element 8. The pressure equalization element 8 is also referred to as a pressure equalization valve.

In the embodiments shown, handles 11 are formed in the side wall 5, as shown in FIGS. 1, 3, 4, and 9. These handles 11 are designed in such a way that they do not form an opening in the side wall 5, i.e., the side wall 5 does not have any openings or breakthroughs in the area of the handles 11. The handles 11 are formed in particular as one piece and/or in one part with the side wall 5. In particular, they form an integral part of the side wall 5.

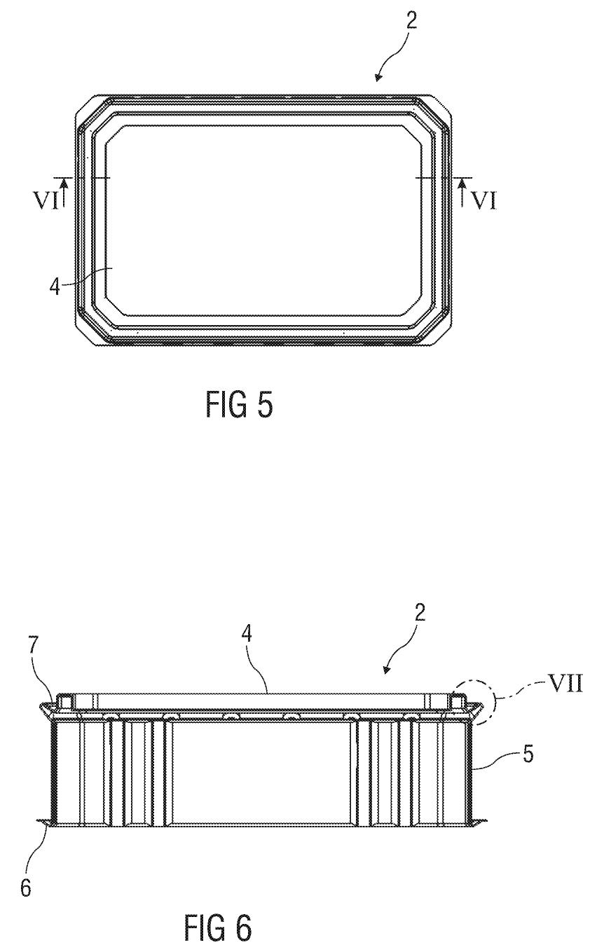

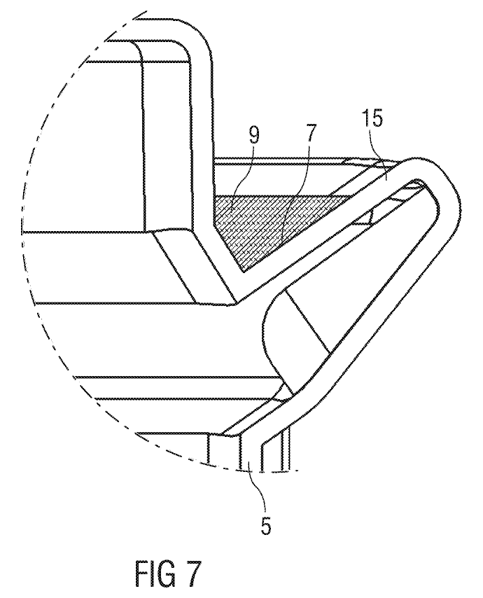

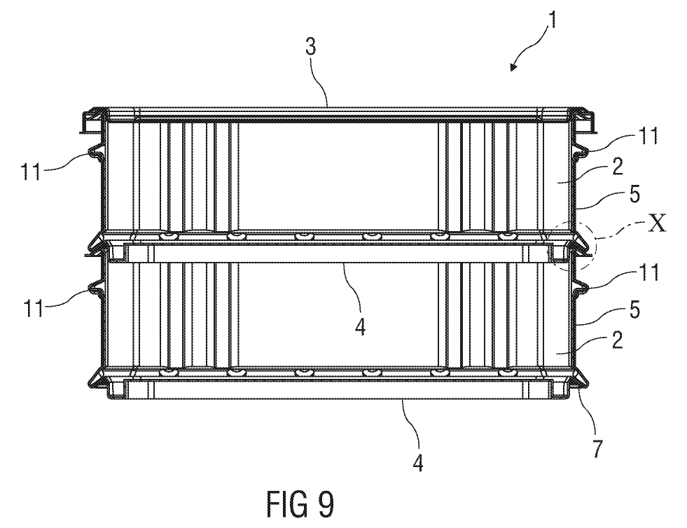

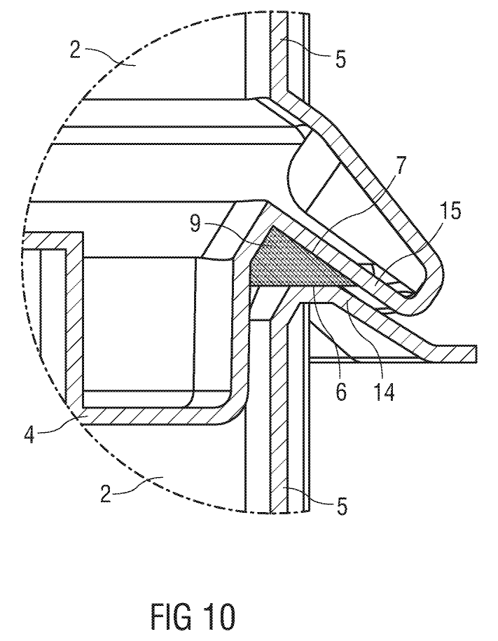

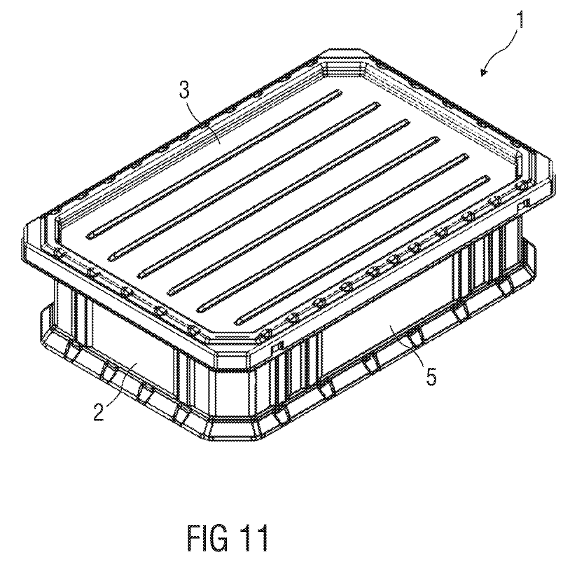

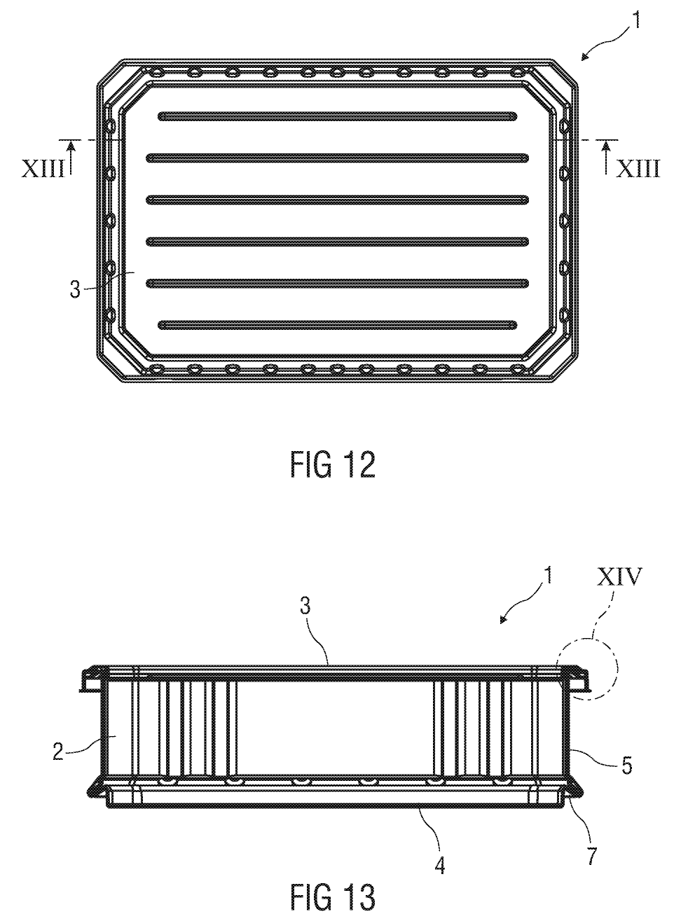

In the embodiments shown, a container seal 9 is circumferentially arranged at the lower stacking edge 7, as shown in FIG. 7 in the detailed view of detail section VII from FIG. 6 and in FIG. 10 in the detailed view of detail section X in FIG. 9. The container 2 is shown upside down in FIGS. 6 and 7, i.e., with the upper container opening of a container interior facing downwards, so that the lower stacking edge 7 is shown at the top. This serves in particular to illustrate a shaping of the lower stacking edge 7 in the embodiments shown as a groove in which the container seal 9 is arranged or is formed in the method for manufacturing the container arrangement 1 in a manner described below.

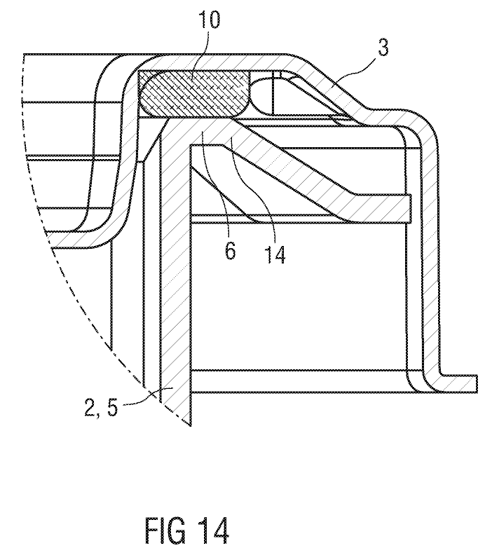

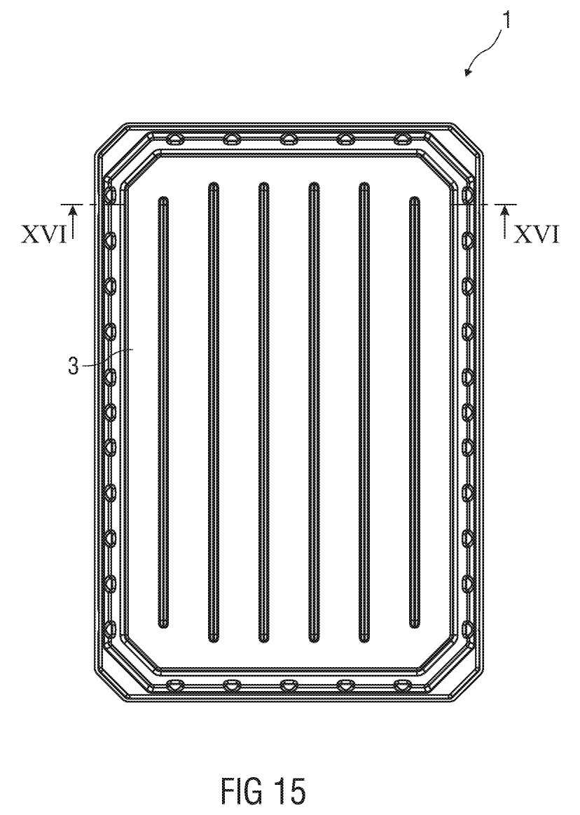

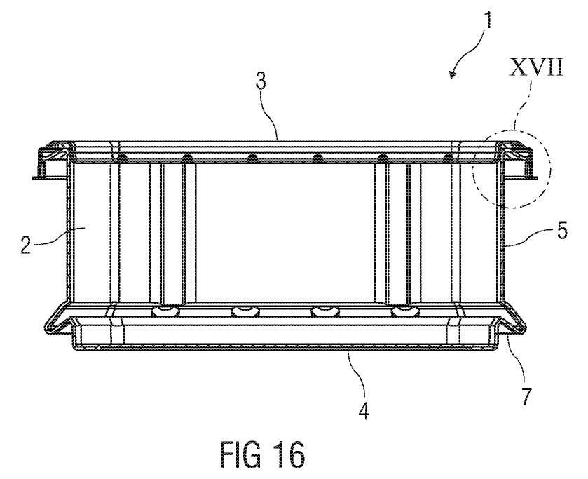

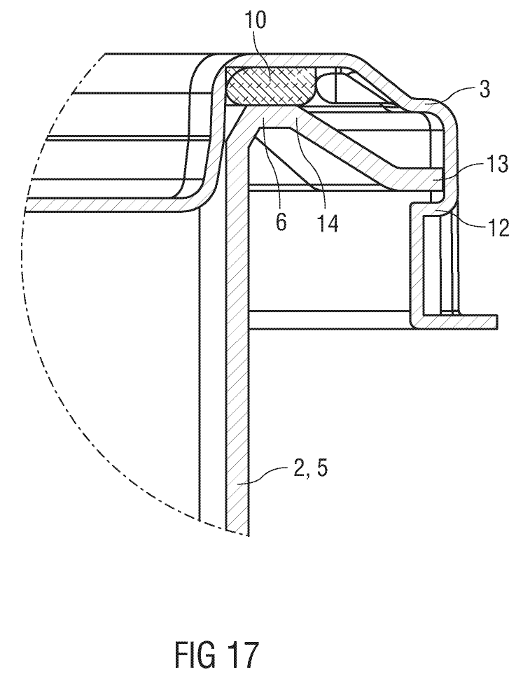

In the embodiments shown, a lid seal 10 is circumferentially arranged at the container closure lid 3, as shown in FIG. 14 in the detailed view of detail section XIV from FIG. 13 and in FIG. 17 in the detailed view of detail section XVII from FIG. 16. In the embodiments shown, the lid seal 10 is arranged on an underside of the container closure lid 3, in particular in a circumferential edge area of the container closure lid 3, in particular the underside of the container closure lid 3.

The container seal 9 of the respective container 2 is arranged and designed in particular such that, when two containers 2 are stacked on top of each other, the container seal 9 of the upper container 2 sealingly abuts the upper stacking edge 6 of the lower container 2, as shown in FIGS. 9 and 10. It thus rests against the upper stacking edge 6 of the lower container 2 and the lower stacking edge 7 of the upper container 2, thereby circumferentially sealing the container opening of the lower container 2. This container opening of the lower container 2 is thus sealed by the container base 4 and the container seal 9 of the upper container 2.

The lid seal 10 of the container closure lid 3 is in particular arranged and designed in such a way that, when the container closure lid 3 is placed on the container 2, the lid seal 10 rests tightly against the upper stacking edge 6 of the container 2. It thus rests against the upper stacking edge 6 of the container 2 and against the container closure lid 3, in particular against its underside, thereby circumferentially sealing the upper container opening of the interior of the container 2. The container opening of the container 2 is thus sealed by the container closure lid 3 and the lid seal 10.

The container seal 9 of the respective container 2 is formed in particular from PU foam, also referred to as PUR foam, in particular from 2K PU foam. The lid seal 10 is in particular formed from PU foam, also referred to as PUR foam, in particular from 2K PU foam. The abbreviation PU stands for polyurethane. The abbreviation 2K stands for two components.

The moisture barrier membrane of the pressure equalization element 8 is in particular formed as a microporous membrane or as a hydrophilic membrane. The moisture barrier membrane, in particular the moisture barrier membrane formed as a microporous membrane, is in particular formed from stretched polytetrafluoroethylene, also referred to as expanded polytetrafluoroethylene (ePTFE).

As shown in FIG. 17 in the detailed view of detail section XVII from FIG. 16, the container closure lid 3 advantageously has locking elements 12 which are designed to lock onto an outer edge 13 of the upper stacking edge 6 when the container closure lid 3 is positioned on the container 2. In the example shown, these locking elements 12 are specifically designed as locking catches that are formed circumferentially around a side edge of the container closure lid 3 and distributed on this side edge of the container closure lid 3. This ensures in particular that the lid seal 10 is pressed against the upper stacking edge 6 of the container 2 with a predetermined pressing force, in particular is pressed in a predetermined manner, when the container closure lid 3 is arranged on the container 2 and latched to the container 2 by means of the locking elements 12.

In a method for manufacturing the container arrangement 1, the receiving opening for the pressure equalization element 8 is made in the side wall 5 of the respective container 2, the pressure equalization element 8 is arranged in the receiving opening, advantageously the container seal 9 is arranged circumferentially on the lower stacking edge 7 of the respective container 2, and advantageously the lid seal 10 is arranged circumferentially on the container closure lid 3. The steps described can be carried out in the order described or in a different order. In particular, the insertion of the receiving opening and/or the arrangement of the pressure equalization element 8 can be carried out before or after the arrangement of the container seal 9 and/or before or after the arrangement of the lid seal 10, and the arrangement of the container seal 9 can be carried out before or after the arrangement of the lid seal 10.

In one embodiment, the respective container 2 is made of plastic in a thermoforming process, especially a plastic deep-drawing process, for example using the tool and/or method described in DE 10 2019 207 818 A1, especially in its figure description and figures.

In one embodiment, the plastic container closure lid 3 is formed in a thermoforming process, in particular a plastic deep-drawing process.

The receiving opening is introduced into the side wall 5 of the respective container 2, for example, during or after the formation of the container. The introduction after the formation of the respective container 2 can be carried out, for example, by drilling or punching.

The container seal 9 is formed on the respective container 2, in particular by applying the PU foam, in particular in the form of a foam bead. The PU foam for forming the container seal 9 is, in particular, an addition-curing 2-component PUR foam. It is, in particular, a PUR material that can be applied directly using a mixing and dosing machine.

In the embodiments shown, the respective container 2 has a groove, in particular a circumferential groove, at the lower stacking edge 7, wherein the container seal 9 is formed in this groove, as shown in particular in FIGS. 7 and 10. This means that the PUR material used to form the container seal 9 can be, for example, a liquid material that can be applied to components with a groove. In particular, this PUR material does not require any additional oven post-treatment for curing, but the curing process can be accelerated, for example, with heat.

The lid seal 10 is formed on the container closure lid 3, in particular by applying the PU foam, in particular in the form of a foam bead. The PU foam for forming the lid seal 10 is, in particular, an addition-curing 2-component PUR soft foam. It is, in particular, a pasty (thixotropic) material that can be applied to components with or, in particular, without a groove. In particular, it does not require any additional oven post-treatment for curing, but the curing process can be accelerated, for example, with heat.

In the embodiments shown, the container closure lid 3 does not have a groove for the lid seal 10, but rather a flat surface on which the lid seal 10 is attached. Therefore, the paste-like (thixotropic) material is used as the PU foam. If the container closure lid 3 has a groove for the lid seal 10, the material used above to form the container seal 9 can also be used to form the lid seal 10, for example. Similarly, if the respective container 2 does not have a groove for the container seal 9, the material used above to form the lid seal 10 can be used to form the container seal 9.

The container seal 9 and/or the lid seal 10, in particular as a foam bead, is applied in particular using the FIPFG (Formed-In-Place-Foam-Gaskets) process. The container seal 9 and/or the lid seal 10 is applied in particular "in situ"; the two-component material is applied directly to the component at the location where the seal 9, 10 is required. The container seal 9 or lid seal 10 then preferably cures at room temperature.

The solution described here for the container arrangement 1 and the method for its manufacture makes it possible, in particular, to prevent moisture damage to components stored and/or transported in the respective container 2. The solution described thus enables, in particular, the transport and/or storage of components at risk of corrosion, for example untreated metals and/or electrical and/or electronic parts and assemblies.

The solution described here solves in particular the problem that condensate or water vapor forms in transport containers known in the art when temperatures change during storage and transport, which can cause corrosion on metals and damage to electronic components.

This is solved by the solution described here, in particular by sealing the interior of the respective container 2, either by means of another container 2 stacked on top of it and its container seal 9, or by means of the container closure lid 3 and its lid seal 10, as well as by the pressure equalization element 8 of the respective container 2. Both this sealing and the pressure equalization element 8 prevent moisture from entering the interior of the respective container 2, whereby the pressure equalization element 8 also allows moisture, in particular water vapor, to escape from the interior of the respective container 2.

In an advantageous embodiment, in particular if the respective container 2, as already mentioned above, is or will be manufactured using the tool and/or method described in DE 10 2019 207 818 A1, in particular in its figure description and figures, before the receiving opening is made in its side wall 5, the pressure equalization element 8 is arranged and the container seal 9 is arranged, it is provided in particular that the container 2 has the container base 4, which is in particular closed, the properties of which are advantageously adapted to a good to be transported. For example, the container base 4 is profiled in such a way that it has so-called nests, which enable the components to be inserted to be transported without slipping or damage. However, depending on requirements, the container base 4 may also have other properties, for example, it may be flat.

The container base 4 is connected to the circumferential side wall 5, which is in particular made of the same material and is closed, in particular with the exception of the opening for the pressure equalization element 8. The upper part of the side wall 5 advantageously ends in an upper flange 14, which is formed circumferentially around the entire container 2, in particular made of the same material, and protrudes in particular beyond an outer side of the side wall 5. This upper flange 14, in particular an upper side of the upper flange 14, advantageously forms the upper stacking edge 6.

In the lower area of the container 2, in particular the side wall 5, a lower flange 15 projecting outwardly is advantageously formed, which advantageously forms the lower stacking edge 7. The lower flange 15 is formed in particular as an inwardly open groove and thus has an upper side and a lower side, the lower side in particular forming the lower stacking edge 7. Advantageously, a section of the side wall 5 protruding downwards from the lower flange 15 in this area is set back by a distance relative to the rest of the side wall 5, which corresponds to at least one material thickness of the side wall 5, but is slightly larger in a possible design, so that several containers 2 can be stacked on top of each other and section by section into each other without jamming.

When stacking the containers 2, the upper container 2 with its container base 4 and the downwardly protruding section of the side wall 5 thus fits into the container opening of the lower container 2 until the container seal 9 of the upper container 2 rests on the upper stacking edge 6 of the lower container 2. The weight of the upper container 2 and, if applicable, the container closure lid 3 arranged on it, as well as any components arranged in the upper container 2, presses the container seal 9 of the upper container 2 tightly against the upper stacking edge 6 of the lower container 2, preferably compressing it slightly, so that the container opening of the lower container 2 is sealed shut.

The lower flange 15 is advantageously inclined on its underside relative to the adjoining section of the side wall 5 and forms an angle with the section of the side wall 5 that is less than 90°, as shown. As described, this underside of the lower flange 15 forms the lower stacking edge 7 of the container 2, whereby this inclined configuration forms the aforementioned groove for receiving the container seal 9.

The upper flange 14 also advantageously forms an angle that is less than 90°, so that when several containers 2 are stacked, the upper flange 14, i.e. the upper stacking edge 6 of the lower container 2, fits with its upper side under the underside of the lower flange 15, i.e. the lower stacking edge 7 of the upper container 2 located directly above it, whereby the container seal 9 arranged on the lower stacking edge 7 of the upper container 2, in particular on the underside of the lower stacking edge 7, is now arranged in a sealing manner between the lower stacking edge 7 of the upper container 2 and the upper stacking edge 6 of the lower container 2, thereby achieving a dust- and moisture-tight connection between the individual containers 2 when stacked.

### LIST OF REFERENCES

1 Container arrangement
2 Container
3 Container closure lid
4 Container base
5 Side wall
6 Upper stacking edge
7 Lower stacking edge
8 Pressure equalization element
9 Container seal
10 Lid seal
11 Handle
12 Locking element
13 Outer edge
14 Upper flange
15 Lower flange

1. A container arrangement comprising a number of containers and a container closure lid, wherein each container has a container base to which a side wall is circumferentially connected, the side wall having a circumferential upper stacking edge in an upper area and a circumferential lower stacking edge in a lower area, wherein a pressure equalization element with a moisture barrier membrane is arranged in the side wall, wherein a container seal is circumferentially arranged at the lower stacking edge, and wherein a lid seal is circumferentially arranged at the container closure lid.

2. The container arrangement according to claim 1,
wherein the container seal of the respective container is arranged and designed such that, when two containers are stacked on top of each other, the container seal of the upper container sealingly abuts the upper stacking edge of the lower container.

3. The container arrangement according to claim 1,
wherein the lid seal of the container closure lid is arranged and designed such that, when the container closure lid is placed on the container, the lid seal fits tightly against the upper stacking edge of the container.

4. The container arrangement according to claim 1,
wherein the container seal and/or the lid seal are/is formed from a PU foam.

5. The container arrangement according to claim 1,
wherein the moisture barrier membrane of the pressure equalization element is made of stretched polytetrafluoroethylene.

6. The container arrangement according to claim 1,
wherein the container closure lid has locking elements which are designed to lock onto an outer edge of the upper stacking edge when the container closure lid is placed on the container.

7. A method for manufacturing a container arrangement, comprising:
making a receiving opening for a pressure equalization element in a side wall of a container,
arranging the pressure equalization element in the receiving opening,
providing a container seal circumferentially arranged at a lower stacking edge of the container, and
arranging a lid seal around a container closure lid.

8. The method according to claim 7,
wherein the respective container and/or the container closure lid are formed from plastic in a thermoforming process.

9. A method according to claim 7,
wherein the receiving opening is formed in the side wall of the respective container during or after the formation of the container.

10. The method according to claim 7,
wherein the container seal is formed on the respective container and/or the lid seal is formed on the container closure lid by applying a PU foam.
